(19) United States
(12) Patent Application Publication
(10) Pub. No.: US 2025/0014029 A1
(43) Pub. Date: Jan. 9, 2025

(54) SYSTEM AND METHOD FOR SMART CONTRACT DECODING AND ENCODING

(71) Applicant: VCB Technologies, LLC, Oxford, PA (US)

(72) Inventor: Karen Root, Oxford, PA (US)

(21) Appl. No.: 18/891,021

(22) Filed: Sep. 20, 2024

Related U.S. Application Data
(62) Division of application No. 17/975,449, filed on Oct. 27, 2022.

(51) Int. Cl. G06Q 20/38

(52) U.S. Cl. CPC G06Q 20/389

(57) ABSTRACT

A system and method for configuring a blockchain platform that stores at least one token. The at least one token can be retrieved from the blockchain platform to obtain contents of a contract within the at least one token. An artificial intelligence/machine learning (AI/ML) engine can be applied to decode the contract to obtain the contents of the contract. The contents of the contract can be verified based on the decoding by the AI/ML engine.

### CROSS-REFERENCE TO RELATED APPLICATIONS

The present application claims priority to U.S. Non-Provisional application Ser. No. 17/975,449 filed Oct. 27, 2022, titled “SYSTEM AND METHOD FOR SMART CONTRACT DECODING AND ENCODING,” and U.S. Provisional Application No. 63/272,331 filed Oct. 27, 2021, titled “SYSTEM AND METHOD FOR SMART CONTRACT DECODING AND ENCODING,” which is hereby incorporated by reference in its entirety.

### TECHNICAL FIELD

The embodiments generally relate to the decoding and encoding of smart contracts.

### BACKGROUND

Smart contracts are computer programs or transaction protocols which are intended to automatically execute, control, or document legally relevant events and actions according to the terms of a contract or an agreement. Smart contracts allow for the reduction in need in trusted intermediators, arbitrations and enforcement costs, fraud losses, and reduces malicious and accidental exceptions. The decentralized, open-source blockchain Ethereum is often used to store smart contracts. However, other blockchains may already exist or may be created which have smart contract functionalities.

In the current arts, human beings develop code for use in blockchain technology, fungible, and non-fungible tokens. As tokens may contain specific terms and conditions, the coders must translate those terms within the program code so that the blockchain and tokens contain the full terms of the contract. However, as the tokens are resold or transacted in some way, the potential new owner must have complete understanding of any smart contracts and their terms and conditions. Today, the only way to decipher the smart contract is to pay a coder to scour and reconstitute the contract. This enables potential for human error, fraud, or scams to occur. The same holds true for the initial creation of the contract code.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a system and method for configuring a blockchain platform that stores at least one token. The at least one token can be retrieved from the blockchain platform to obtain contents of a contract within the at least one token. An artificial intelligence/machine learning (AI/ML) engine can be applied to decode the contract to obtain the contents of the contract. The contents of the contract can be verified based on the decoding of the AI/ML engine.

The system uses an AI/ML engine to decode smart contracts from coded programming into laymen terms and can apply the reverse for encoding contract terms and conditions for program coding. Using machine language processing, this process can be done more accurately, without bias, and without fraud at the human coding level.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a flowchart of the smart contract decoding process, according to some embodiments; and

FIG. 3 illustrates a flowchart of the smart contract encoding process, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a system for decoding and encoding smart contracts. The system uses artificial intelligence and machine learning to translate smart contracts from coded programming into laymen terms and can apply the reverse for encoding contract terms and conditions for program coding. Using machine language processing, this process can be done more accurately, without bias, and without fraud at the human coding level.

The system would decode any existing smart contracts and compile a laymen readable translation of the smart contracts which may be accessible through the blockchain or token. Should an owner wish to create a smart contract, those terms and conditions can be coded according to applicable blockchain technology using artificial intelligence and machine learning of any and all related blockchain technology to create a smart contract.

The system may be used as a component of a blockchain platform to automatically store the smart contract and associated information or may be offered as a third-party platform wherein the user may copy and paste prior to storing on the blockchain platform. The system may further be offered as a standalone product to allow the copy and paste of the smart contract information.

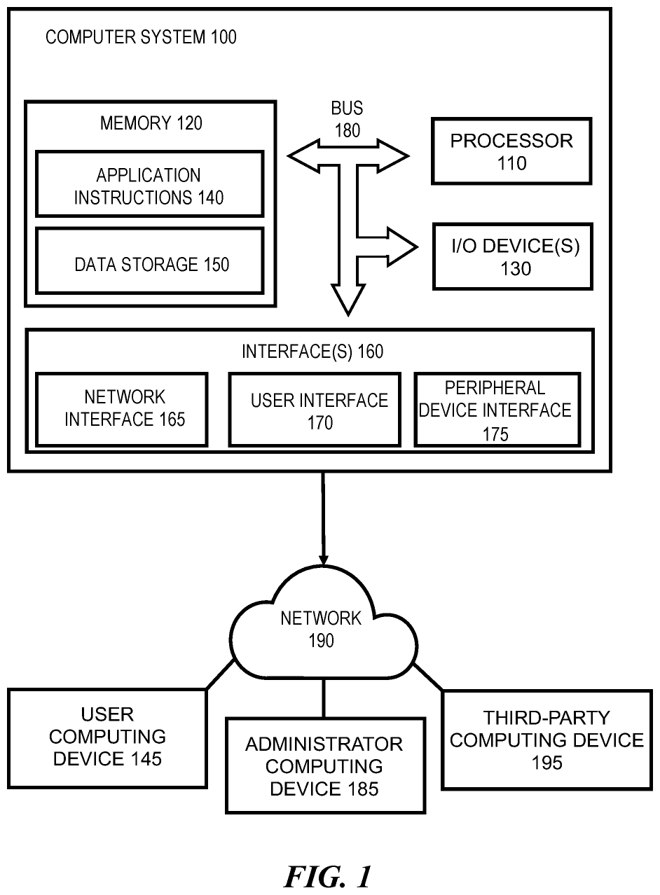

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

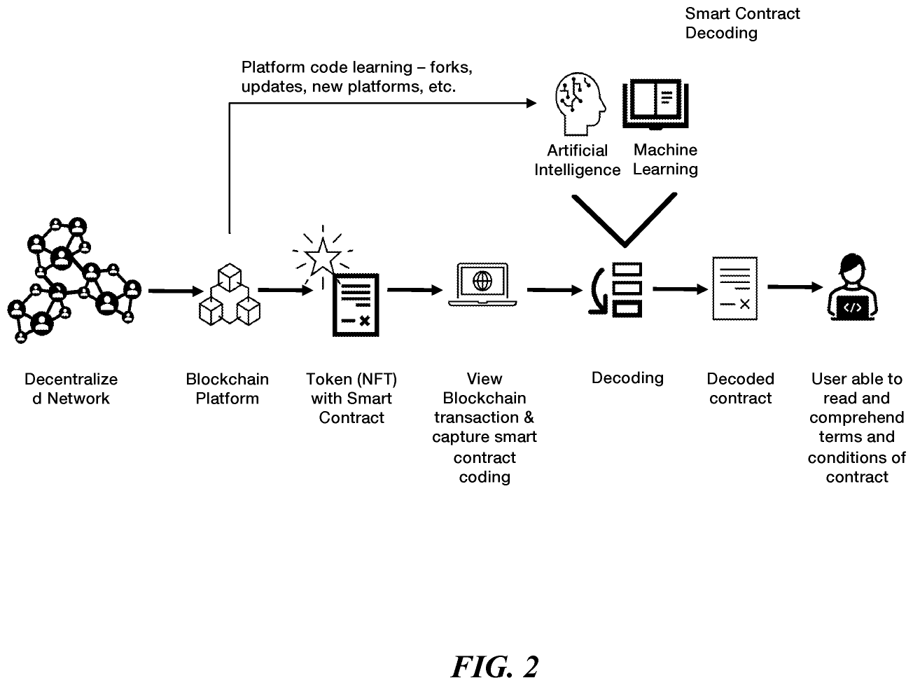

FIG. 2 illustrates a flowchart of the smart contract decoding process wherein a decentralized network is in communication with a blockchain platform storing a token (e.g., a non-fungible token) with a smart contract. The blockchain transaction can be viewed and the smart contract coding is captured. Once the smart contract coding is captured, an artificial intelligence engine and machine learning engine may decode the smart contract. The decoded smart contract is transmitted to user who is now able to read the decoded smart contract. In such, the user can comprehend terms and conditions of the contract which is not possible when the smart contract is encoded.

The terms and conditions of a smart contract are recorded in a computer language, (programming language, machine language) as a set of instructions that most typically utilize if/then logic. The contract is auto executed within a distributed ledger system or blockchain.

In some embodiments, the smart contract may be verified, validated and/or stored in a third-party blockchain platform. The user may not necessarily proceed using automated (auto-executed) smart contract execution depending on the blockchain platform being utilized.

The blockchain technologies may vary by type and the artificial intelligence and/or machine learning algorithms are applied through various programming languages (Solidity, C++, Go, Python, Java, etc.) as part of the key data translation from programming language to natural language.

Augmented intelligence is utilized to decode the contract. Utilizing direct code, machine learning and/or artificial intelligence (AI) algorithms to produce an intelligent system which performs the cognitive functions to interpret the terms and conditions of the smart contract as written in code, then based on the learned data, produces the predicted results in the form of natural language.

In some embodiments, the system may utilize a natural language processing engine as a component of the machine learning engine and artificial intelligence engine. The natural language processing engine enables the translation of information such that information from the smart contract may be transformed into laymen's terms which can be reviewed by the user.

Artificial Intelligence may include Type 1 and/or Type 2 forms of intelligence. Machine learning is a type of AI where a computer is trained to automate tasks for human beings. Machine learning uses data to feed an algorithm that can understand the relationship between the input and the output. Machine learning allows the decoding of smart contracts to become more accurate, safer from fraud and scams in working across different programming languages. It is based on the input of data to train the machine learning algorithm and development of a model that will process data through the algorithm with a clear prediction and evaluation to confirm the accuracy of the learning. The machine algorithm's purpose is to hypothesize a specific type of approach for processing data in the most reliable way possible and define the predictive model for that process.

The process of machine learning includes gathering data, preparing the data, wrangling data, analysis of the data, which is then used to train the model, test the model and deploy the model of contract decoding. It is comprised of the collection and preprocessing of data, feature extraction and selection, choosing and evaluating a decoding model, training the model, and evaluating and testing the model. The use of computer programming language to provide the most accurate translation of code to natural language including sentences or words, numbers, descriptors and characters as needed to effectively describe the terms and conditions comprising the smart contract.

The augmented intelligence may include one or more types of learning algorithms for programming language encoding to natural language through unsupervised, supervised, semi-supervised, and/or reinforcement learning algorithm types.

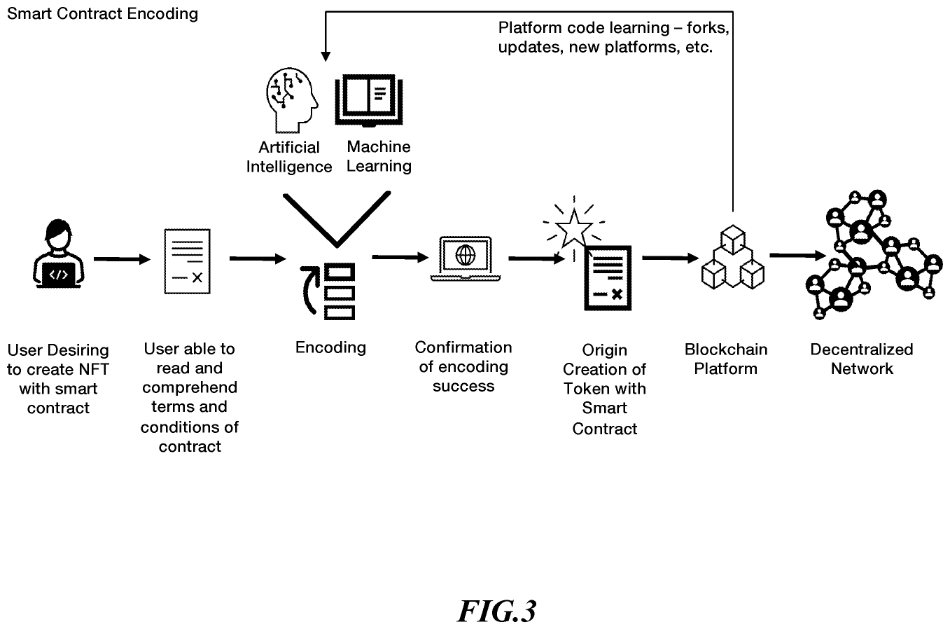

FIG. 3 illustrates a flowchart of the smart contract encoding process. If a user desires to create a non-fungible token (NFT) with a smart contract, they generate or otherwise source a contract which is readable and comprehendible by a laymen. An artificial intelligence engine and machine learning engine encode the smart contract and a confirmation is transmitted once the encoding process is complete. Once the smart contract is encoded, the token is created and recorded in the blockchain platform in a decentralized network.

In some embodiments, the smart contract may be verified, validated and/or stored in a third-party blockchain platform. The user may not necessarily proceed using automated (auto-executed) smart contract execution depending on the blockchain platform being utilized.

The terms and conditions of a smart contract are recorded in a computer language, (programming language, machine language) as a set of instructions that most typically utilize if/then logic. The contract must be executed outside of the contract by a distributed ledger system or blockchain. The (auto-) execution of an encoded smart contract requires inclusion within the blockchain. In some embodiments, the smart contract is auto-executed when all conditions of the contract are met.

The blockchain technologies may vary by type and the artificial intelligence and machine learning algorithms are applied through various programming languages (Solidity, C++, Go, Python, Java, etc.) as part of the key data translation from natural language to programming language. The smart contract is then executed by the blockchain as part of the process of a decentralized network to place the technology in hands of multiple people to process a distributed ledger system.

Augmented intelligence is utilized to encode the contract. Utilizing direct code, machine learning and/or artificial intelligence (AI) algorithms to produce an intelligent system which performs the cognitive functions to interpret the terms and conditions of the smart contract as written in natural language, then based on the learned data, specific code and blockchain technology, produces the predicted results in the form of programming language.

Artificial Intelligence may include Type 1 and/or Type 2 forms of intelligence. Machine learning is a type of AI where a computer is trained to automate tasks for human beings. Machine learning uses data to feed an algorithm that can understand the relationship between the input and the output. Machine learning allows the encoding of smart contracts to become more accurate, safer from fraud and scams in working across different programming languages. It is based on the input of data to train the machine learning algorithm and development of a model that will process data through the algorithm with a clear prediction and evaluation to confirm the accuracy of the learning. The machine algorithm's purpose is to hypothesize a specific type of approach for processing data in the most reliable way possible and define the predictive model for that process.

The process of machine learning includes gathering data, preparing the data, wrangling data, analysis of the data, which is then used to train the model, test the model and deploy the model of contract encoding. It is comprised of the collection and preprocessing of data, feature extraction and selection, choosing and evaluating an encoding model, training the model, and evaluating and testing the model. The use of computer programming language to provide the most accurate translation of natural language to code or computer programming language.

The augmented intelligence may include any type of learning algorithms for programming language encoding to natural language through unsupervised, supervised, semisupervised, and/or reinforcement learning algorithm types.

Various forms of blockchain platforms may be utilized. For example, known public blockchain platforms may be used such as Bitcoin, Ethereum, Litecoin, and other altcoins which are permissionless, free access, and include shared ledgers. Private blockchains, federated blockchains, and hybrid blockchains known in the arts may also be utilized.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A computer-implemented method comprising:
configuring a blockchain platform that stores at least one token;
retrieving the at least one token from the blockchain platform to obtain contents of a contract within the at least one token;
applying an artificial intelligence/machine learning (AI/ML) engine to decode the contract to enable the contents of the contract to be obtained;
verifying the contents of the contract based on the decoding by the AI/ML engine.

2. The computer-implemented method of claim 1, further comprising:
capturing a coding of the contract within the last least one token before the decoding by the AI/ML.

3. The computer-implemented method of claim 1, further comprising:
verifying the contract for accuracy before storing the contract within the blockchain platform.

4. The computer-implemented method of claim 1, further comprising:
configuring a de-centralized network to be in communication with the blockchain network.

5. The computer-implemented method of claim 1, further comprising:
applying the AI/ML engine to encode the contract within the blockchain platform.

6. The computer-implemented method of claim 1, further comprising:
identifying terms and conditions of the contract based on the decoding of the AI/ML.

7. The computer-implemented method of claim 1, further comprising:
transmitting the decoded contract for verification to one or more intended recipients.

8. A system comprising:
a processor;
a non-transitory computer-readable storage medium having stored thereon instructions, that when executed by the processor, cause the processor to perform operations comprising:
configuring a de-centralized network at an initial position;
positioning a blockchain platform in communication with the de-centralized network, wherein the blockchain platform stores one or more contracts represented by at least one token;
identifying a blockchain transaction within the blockchain platform involving the at least one token, wherein the blockchain transaction is identified to capture coding of the one or more contracts; and
decoding the one or more contracts by an artificial intelligence/machine-learning (AI/ML) engine.

9. The system of claim 8, wherein the processor is further configured to perform the operations comprising:
transmitting the one or more contracts to at least one recipient for viewing.

10. The system of claim 8, wherein the processor is further configured to perform the operations comprising:
applying the AI/ML engine to encode the one or more contracts for storage into the blockchain platform.

11. The system of claim 8, wherein the processor is further configured to perform the operations comprising:
validating the one or more contracts before storing the one or more contracts within the blockchain platform.

12. The system of claim 8, wherein the processor is further configured to perform the operations comprising:
recording and identifying terms of the one or more contracts before storing the one or more contracts within the blockchain platform.

13. The system of claim 8, wherein the processor is further configured to perform the operations comprising:
applying the AI/ML engine to decode the one or more contracts from a code to a natural language.

14. The system of claim 8, wherein the processor is further configured to perform the operations comprising:
applying a natural language engine to assist the AI/ML engine in decoding the one or more contracts.

15. A non-transitory computer-readable storage medium having stored thereon instructions that, when executed by a computing device, cause the computing device to perform operations comprising:
positioning a blockchain platform within a network, wherein the blockchain platform stores a token that represents a contract;
identifying a blockchain transaction involving the blockchain platform, wherein the contract within the token is captured as a result of the identified blockchain transaction;
applying an artificial intelligence/machine-learning (AI/ML) engine to decode the contract, wherein the contract is decoded to obtain a natural language of contents within the contract; and
transmitting the decoded contract to one or more recipients.

16. The non-transitory computer-readable storage medium of claim 15, wherein the computing device performs the operations that further comprise:
applying the AI/ML engine to encode the contract from the natural language to a code to store within the blockchain platform.

17. The non-transitory computer-readable storage medium of claim 15, wherein the computing device performs the operations that further comprise:
applying augmented intelligence to decode the contract.

18. The non-transitory computer-readable storage medium of claim 15, wherein the computing device performs the operations that further comprise:
identifying terms and conditions written in a code after identifying the blockchain transaction.

19. The non-transitory computer-readable storage medium of claim 15, wherein the computing device performs the operations that further comprise:
applying a natural language processing engine to translate terms and conditions of the contract from a code into natural language.

20. The non-transitory computer-readable storage medium of claim 15, wherein the AI/ML engine increases an accuracy level of the decoding of the contract.
